(19) United States
(12) Patent Application Publication
(10) Pub. No.: US 2018/0135849 A1
(43) Pub. Date: May 17, 2018

(54) Illuminated Shower Rod Assembly

(71) Applicant: Christopher Paseta, Coral Springs, FL (US)

(72) Inventor: Christopher Paseta, Coral Springs, FL (US)

(21) Appl. No.: 15/352,648

(22) Filed: Nov. 16, 2016

(51) Int. Cl. F21V 33/00; A47K 3/38; A47H 1/02; F21V 21/22; F21V 15/015; F21V 23/00; F21V 23/04; F21V 23/02

(52) U.S. Cl. CPC F21V 33/004; A47K 3/38; A47H 1/02; F21V 21/22; F21Y 2115/10; F21V 23/001; F21V 23/04; F21V 23/02; A47H 2001/0215; F21V 15/015

(57) ABSTRACT

An illuminated shower rod assembly for illuminating a shower includes a tube that may be extended between opposing walls of a shower. A lighting unit is coupled to the tube. The lighting unit emits light outwardly from the tube. Thus, the shower is illuminated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shower rod devices and more particularly pertains to a new shower rod device for illuminating a shower.

### BRIEF SUMMARY OF THE INVENTION

An embodiment of the disclosure meets the needs presented above by generally comprising a tube that may be extended between opposing walls of a shower. A lighting unit is coupled to the tube. The lighting unit emits light outwardly from the tube. Thus, the shower is illuminated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an illuminated shower rod assembly according to an embodiment of the disclosure.

FIG. 2 is an exploded perspective view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

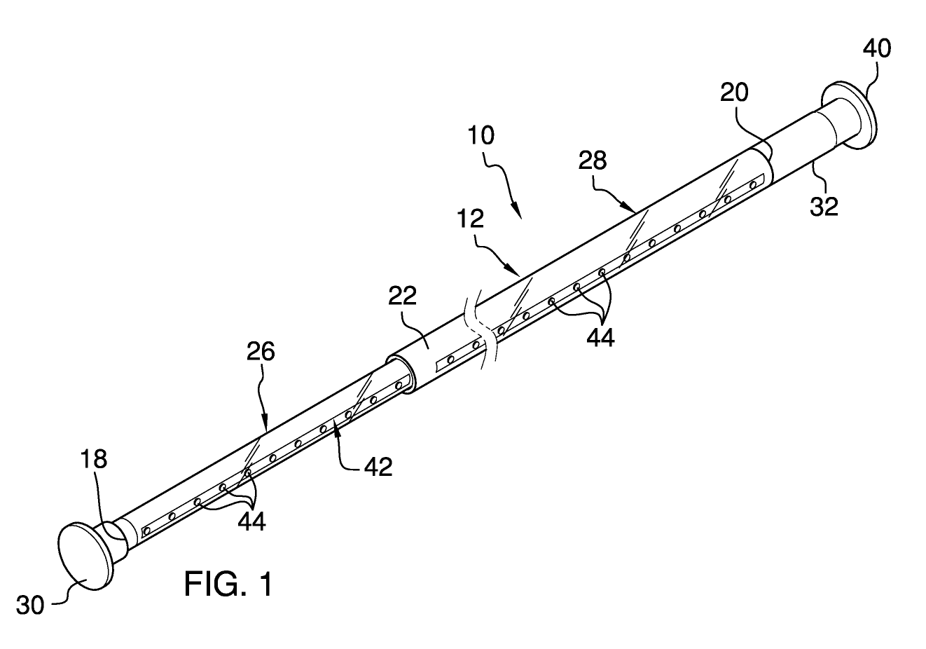

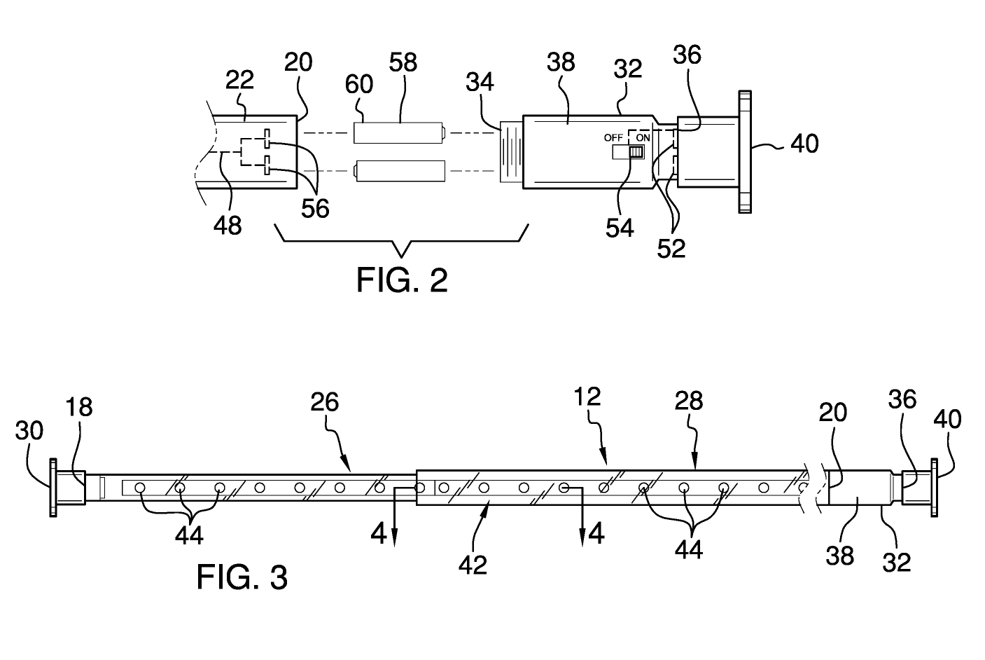

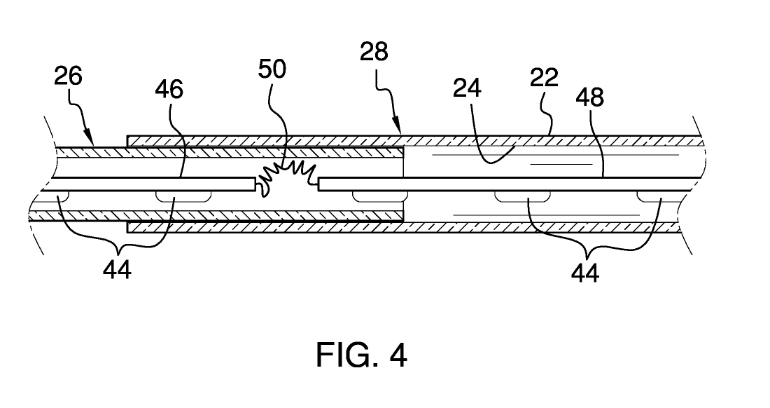

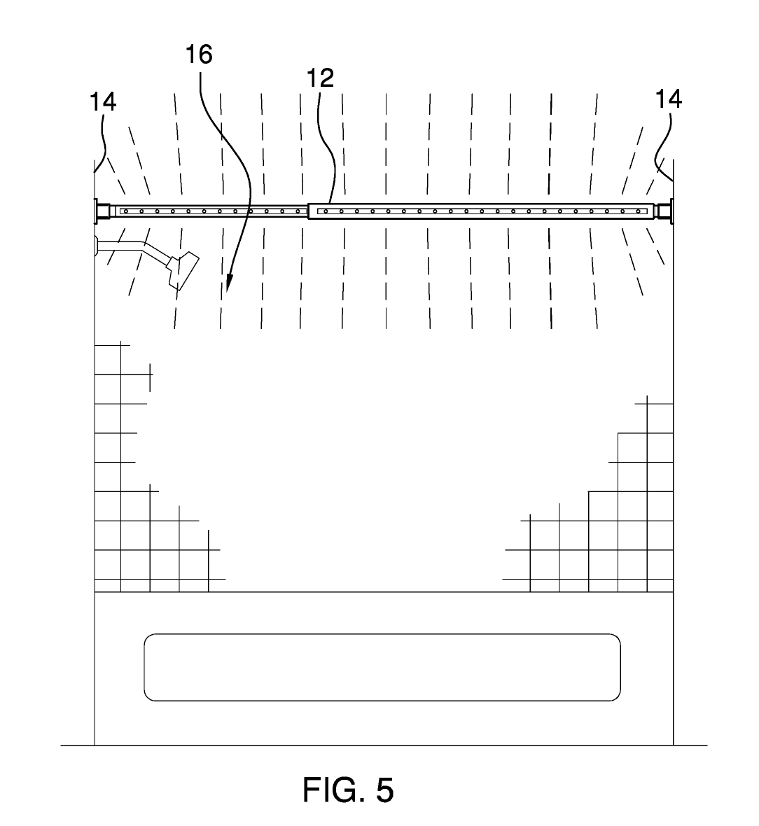

With reference now to the drawings, and in particular to FIGS. 1 through 5 thereof, a new shower rod device embodying the principles and concepts of an embodiment of the disclosure and generally designated by the reference numeral 10 will be described.

As best illustrated in FIGS. 1 through 5, the illuminated shower rod assembly 10 generally comprises a tube 12. The tube 12 may be extended between opposing walls 14 of a shower 16. The shower 16 may be a bathing shower or the like. The tube 12 may support a shower curtain or the like.

The tube 12 has a first end 18, a second end 20 and an outer wall 22 extending therebetween. The second end 20 is open and the outer wall 22 has an inner surface 24. Moreover, the tube 12 comprises a first half 26 slidably coupled to a second half 28. Thus, the tube 12 has a telescopically adjustable length. A first foot 30 is coupled to the first end 18. The first foot 30 frictionally engages an associated one of the opposing walls 14 of the shower 16.

A cap 32 is provided that has a primary end 34, a secondary end 36 and an outside wall 38 extending therebetween. The outside wall 38 is continuous such that the cap 32 has a cylindrical shape. Moreover, the outside wall 38 is threaded adjacent to the primary end 34. The outside wall 38 threadably engages the inner surface 24 of the tube 12 such that the cap 32 is removably coupled to the second end 20. A second foot 40 is coupled to the secondary end 36. The second foot 40 frictionally engages an associated one of the opposing walls 14 of the shower 16.

A lighting unit 42 is provided. The lighting unit 42 is coupled to the tube 12. The lighting unit 42 emits light outwardly from the tube 12. Thus, the shower 16 is illuminated in the absence of existing lighting.

The lighting unit 42 comprises a plurality of light emitters 44. Each of the light emitters 44 is coupled to the outer wall 22 of the tube 12. The light emitters 44 are spaced apart from each other and distributed between the first end 18 and the second end 20 of the tube 12. Each of the light emitters 44 may be an LED or the like.

A first conductor 46 is electrically coupled between each of the light emitters 44 corresponding to the first half 26 of the tube 12. The first conductor 46 is positioned within the tube 12. A second conductor 48 is electrically coupled between each of the light emitters 44 corresponding to the second half 28 of the tube 12. The second conductor 48 is positioned within the tube 12.

A third conductor 50 is provided. The third conductor 50 is electrically coupled between the first conductor 46 and the second conductor 48. The third conductor 50 is coiled up within the tube 12 when the tube 12 is positioned in a retracted position. The third conductor 50 is stretched between the first conductor 46 and the second conductor 48 when the tube 12 is positioned in an extended position.

A plurality of first contacts 52 is provided. Each of the first contacts 52 is coupled to the primary end 34 of the cap 32. A switch 54 is coupled to the outside wall 38 of the cap 32 and the switch 54 may be manipulated. The switch 54 is electrically coupled to each of the plurality of first contacts 52. A plurality of second contacts 56 is provided and each of the second contacts 56 is positioned within the tube 12. The first conductor 46 is electrically coupled to each of the second contacts 56.

A power supply 58 is provided. The power supply 58 is removably positioned within the second end 20 of the tube 12. The power supply 58 is placed in electrical communication between each of the first contacts 52 and each of the second contacts 56 when the cap 32 is coupled to the tube 12. Thus, the switch 54 turns each of the light emitters 44 on and off. The power supply 58 comprises at least one battery 60.

In use, the power supply 58 is positioned in the tube 12 and the cap 32 is coupled to the tube 12. The tube 12 is manipulated to extend between the opposing walls 14 of the shower 16. Moreover, the tube 12 is positioned such that each of the light emitters 44 faces the shower 16. The switch 54 is manipulated to turn the light emitters 44 on. Thus, the shower 16 is illuminated. The light emitters 44 facilitate the shower 16 to be illuminated in the absence of existing lighting in the shower 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated shower rod assembly being configured to illuminate a shower, said assembly comprising:
a tube being configured to be extended between opposing walls of a shower; and
a lighting unit being coupled to said tube wherein said lighting unit is configured to emit light outwardly from said tube thereby facilitating the shower to be illuminated.

2. The assembly according to claim 1, wherein said tube has a first end, a second end and an outer wall extending therebetween, said second end being open, said outer wall having an inner surface, said tube comprising a first half being slidably coupled to a second half such that said tube has a telescopically adjustable length, said tube having a first foot being coupled to said first end wherein said first foot is configured to abut an associated one of the opposing walls of the shower.

3. The assembly according to claim 1, further comprising a cap having a primary end, a secondary end and an outside wall extending therebetween, said outside wall being continuous such that said cap has a cylindrical shape, said outside wall being threaded adjacent to said primary end.

4. The assembly according to claim 3, wherein:
said tube has an inner surface and a second end; and
said outside wall threadably engaging said inner surface of said tube such that said cap is removably coupled to said second end, said cap having a second foot being coupled to said secondary end wherein said second foot is configured to abut an associated one of the opposing walls of the shower.

5. The assembly according to claim 2, wherein said lighting unit comprises a plurality of light emitters, each of said light emitters being coupled to said outer wall of said tube, said light emitters being spaced apart from each other and being distributed between said first end and said second end of said tube.

6. The assembly according to claim 5, further comprising a first conductor being electrically coupled between each of said light emitters corresponding to said first half of said tube, said first conductor being positioned within said tube.

7. The assembly according to claim 5, further comprising a second conductor being electrically coupled between each of said light emitters corresponding to said second half of said tube, said second conductor being positioned within said tube.

8. The assembly according to claim 7, further comprising:
a first conductor being positioned within said tube; and
a third conductor being electrically coupled between said first conductor and said second conductor, said third conductor being coiled up within said tube when said tube is positioned in a retracted position, said third conductor being stretched between said first conductor and said second conductor when said tube is positioned in an extended position.

9. The assembly according to claim 3, further comprising a plurality of first contacts, each of said first contacts being coupled to said primary end of said cap.

10. The assembly according to claim 9, further comprising a switch being coupled to said outside wall of said cap wherein said switch is configured to be manipulated, said switch being electrically coupled to each of said plurality of first contacts.

11. The assembly according to claim 1, further comprising:
a first conductor; and
a plurality of second contacts, each of said second contacts being positioned within said tube, said first conductor being electrically coupled to each of said second contacts.

12. The assembly according to claim 11, further comprising:
said tube having a second end;
a plurality of first contacts;
a switch;
a plurality of light emitters; and
a power supply being removably positioned within said second end of said tube, said power supply being placed in electrical communication between each of said first contacts and each of said second contacts when said cap is coupled to said tube such that said switch turns each of said light emitters on and off, said power supply comprising at least one battery.

13. An illuminated shower rod assembly being configured to illuminate a shower, said assembly comprising:
a tube being configured to be extended between opposing walls of a shower, said tube having a first end, a second end and an outer wall extending therebetween, said second end being open, said outer wall having an inner surface, said tube comprising a first half being slidably coupled to a second half such that said tube has a telescopically adjustable length, said tube having a first foot being coupled to said first end wherein said first foot is configured to abut an associated one of the opposing walls of the shower;
a cap having a primary end, a secondary end and an outside wall extending therebetween, said outside wall being continuous such that said cap has a cylindrical shape, said outside wall being threaded adjacent to said primary end, outside wall threadably engaging said inner surface of said tube such that said cap is removably coupled to said second end, said cap having a second foot being coupled to said secondary end wherein said second foot is configured to abut an associated one of the opposing walls of the shower; and
a lighting unit being coupled to said tube wherein said lighting unit is configured to emit light outwardly from said tube thereby facilitating the shower to be illuminated, said lighting unit comprising:
a plurality of light emitters, each of said light emitters being coupled to said outer wall of said tube, said light emitters being spaced apart from each other and being distributed between said first end and said second end of said tube,
a first conductor being electrically coupled between each of said light emitters corresponding to said first half of said tube, said first conductor being positioned within said tube,
a second conductor being electrically coupled between each of said light emitters corresponding to said second half of said tube, said second conductor being positioned within said tube,
a third conductor being electrically coupled between said first conductor and said second conductor, said third conductor being coiled up within said tube when said tube is positioned in a retracted position, said third conductor being stretched between said first conductor and said second conductor when said tube is positioned in an extended position,
a plurality of first contacts, each of said first contacts being coupled to said primary end of said cap,
a switch being coupled to said outside wall of said cap wherein said switch is configured to be manipulated, said switch being electrically coupled to each of said plurality of first contacts,
a plurality of second contacts, each of said second contacts being positioned within said tube, said first conductor being electrically coupled to each of said second contacts, and
a power supply being removably positioned within said second end of said tube, said power supply being placed in electrical communication between each of said first contacts and each of said second contacts when said cap is coupled to said tube such that said switch turns each of said light emitters on and off, said power supply comprising at least one battery.
